(19) United States
(12) Patent Application Publication
(10) Pub. No.: US 2008/0167041 A1
(43) Pub. Date: Jul. 10, 2008

(54) METHOD AND APPARATUS FOR HANDOVER USING A CANDIDATE SET

(75) Inventors: Peter S. Wang, E. Setauket, NY (US); Jin Wang, Central Islip, NY (US); James M. Miller, Verona, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/969,526

(22) Filed: Jan. 4, 2008

Related U.S. Application Data
(60) Provisional application No. 60/883,394, filed on Jan. 4, 2007.

(51) Int. Cl. H04Q 7/20

(52) U.S. Cl. 455/436

(57) ABSTRACT

A method for handover using a handover (HO) candidate set includes receiving measurement statistic parameters. Statistics in a serving cell and potential target cells are measured. An HO candidate set is generated based upon the measured statistics in the serving cell and potential target cells, and the measured statistics are reported. A handing over to one of the potential target cells is performed, wherein a decision to handover to the one of the potential target cells is based upon the measured statistics of the cells in the HO candidate set.

### CROSS REFERENCE TO RELATED APPLICATION

This application claims the benefit of U.S. Provisional Application No. 60/883,394, filed Jan. 4, 2007, which is incorporated by reference as if fully set forth.

### FIELD OF INVENTION

The present invention is related to wireless communication systems.

### BACKGROUND

As part of the long term evolution (LTE) of the third generation partnership project (3GPP), it has been determined that in a radio resource controller connected state (RRC_Connected), a wireless transmit/receive unit (WTRU) should follow the measurement configuration specified by the RRC directed by an enhanced universal mobile telecommunication system (UMTS) radio access network (E-UTRAN). Specifically, in a system where mobility within the same frequency layer is predominant, good neighbor cell measurements are needed for cells that have the same carrier frequency as the serving cell. This facilitates good mobility support and network deployment.

Since in an LTE network, an enhanced Node-B (eNB) or E-UTRAN is utilized to make the handover decision and the target cell selection together with neighboring eNBs/E-UTRANs, handover specific considerations and mechanisms are needed to obtain optimal mobility results for both the LTE system and the WTRUs within it. Currently, a WTRU in a connected mode, or state, is given a large number of cells for measurement. In this manner, a larger report, or larger report amount, than necessary may be created and may not provide much aid in determining whether or not, and how, a handover should occur. There is no measurement scheduling technique to optimize a WTRU handover measurement in a self-regulated manner, nor is there the generation of a “candidate set” for handover. Additionally, there is no provision for an access network to optimize a handover target cell selection. It would therefore be beneficial to provide a method and apparatus to aid in handover using a candidate set.

### SUMMARY

A method for handover using a handover (HO) candidate set is disclosed. The method includes receiving measurement statistic parameters. Statistics in a serving cell and potential target cells are measured. An HO candidate set is generated based upon the measured statistics in the serving cell and potential target cells, and the measured statistics are reported. A handing over to one of the potential target cells is performed, wherein a decision to handover to the one of the potential target cells is based upon the measured statistics of the cells in the HO candidate set.

### BRIEF DESCRIPTION OF THE DRAWINGS

A more detailed understanding may be had from the following description, given by way of example and to be understood in conjunction with the accompanying drawings wherein:

FIG. 1 shows an example wireless communication system including a plurality of WTRUs and a plurality of Node-Bs;

FIG. 2 is a functional block diagram of a WTRU and Node-B of FIG. 1;

FIG. 3 is a flow diagram of a method of generating a candidate set for handover; and

FIG. 4 is an example signal diagram showing a handover sequence using a handover candidate set.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

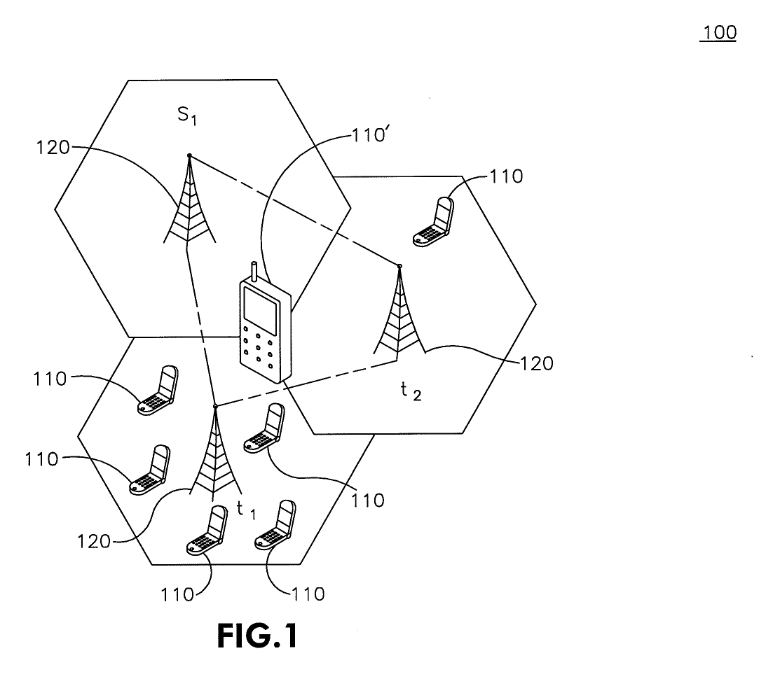

FIG. 1 shows an example wireless communication system 100 including a plurality of WTRUs 110 and a plurality of Node-Bs 120. As shown in FIG. 1, a WTRU 110 (designated 110′) is being served by the Node-B 120 in cell S₁. After handover, the WTRU 110′ is capable of being served by either the Node-B in target cell t₁ or the Node-B in target cell t₂. For purposes of example, the Node-B 120 of target cell t₁ is shown as having more WTRUs 110 currently served than the one in target cell t₂. The Node-Bs 120 are in communication with one another over an interface. For example, the Node-Bs 120 may communicate with one another over an X2 interface.

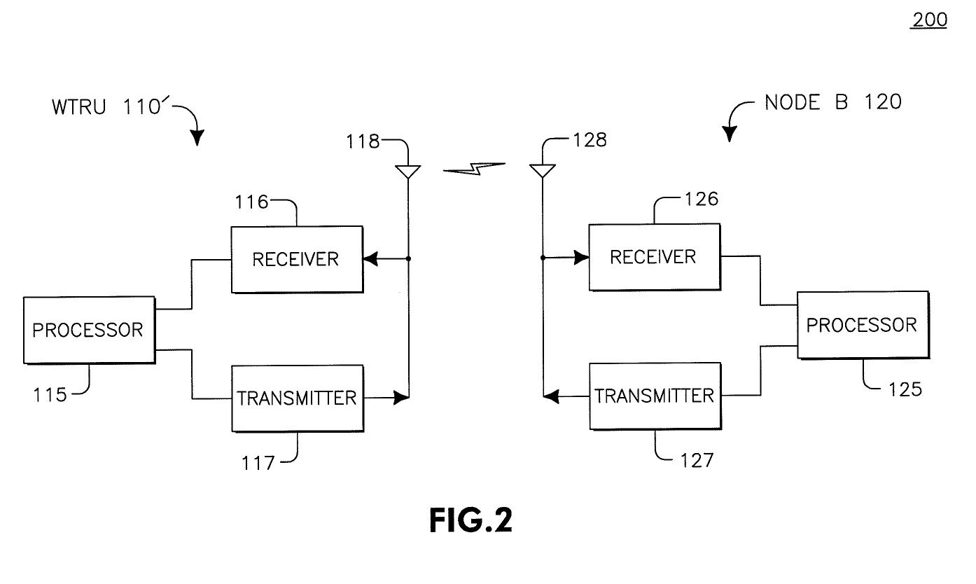

FIG. 2 is a functional block diagram 200 of the WTRU 110′ and the Node-B 120 of the wireless communication system 100 of FIG. 1. As shown in FIG. 2, the WTRU 110′ is in communication with the Node-B 120 and both are configured to perform a method of handover using a candidate set.

In addition to the components that may be found in a typical WTRU, the WTRU 110′ includes a processor 115, a receiver 116, a transmitter 117, and an antenna 118. The processor 115 is configured to perform a method of handover using a candidate set, as described by way of example in more detail below. The receiver 116 and the transmitter 117 are in communication with the processor 115. The antenna 118 is in communication with both the receiver 116 and the transmitter 117 to facilitate the transmission and reception of wireless data.

In addition to the components that may be found in a typical Node-B, the Node-B 120 includes a processor 125, a receiver 126, a transmitter 127, and an antenna 128. The processor 125 is configured to perform a method of handover using a candidate set, as described by way of example in more detail below. The receiver 126 and the transmitter 127 are in communication with the processor 125. The antenna 128 is in communication with both the receiver 126 and the transmitter 127 to facilitate the transmission and reception of wireless data.

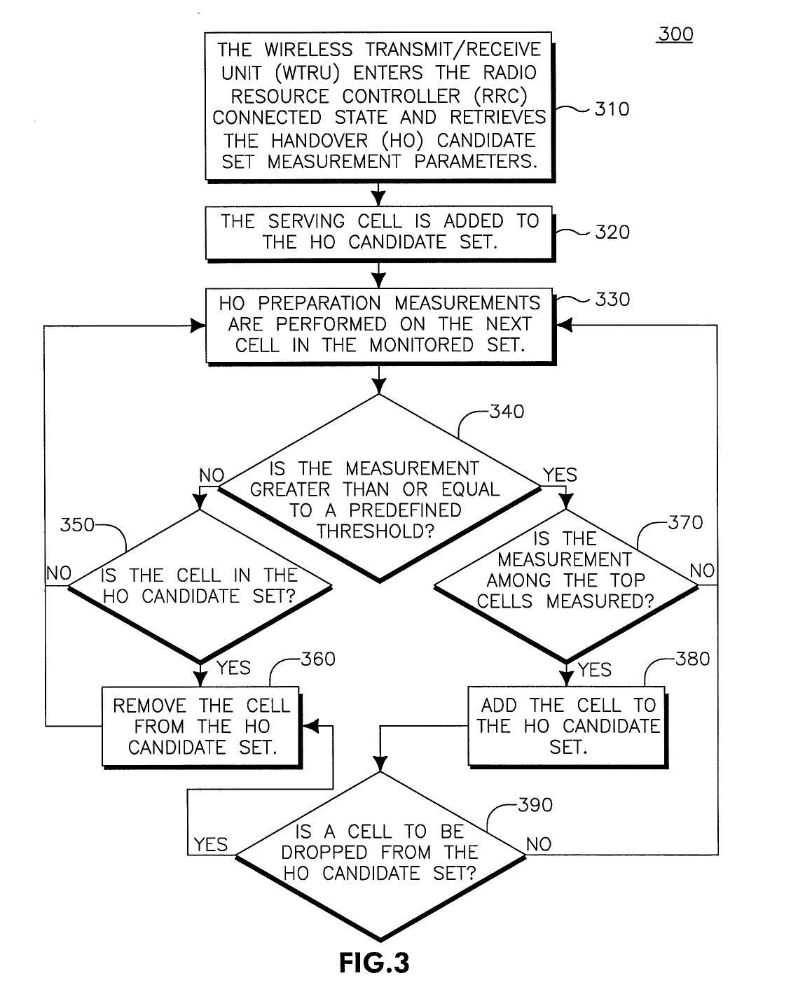

FIG. 3 is a flow diagram of a method 300 of generating a candidate set for handover. For purposes of example, the WTRU 110′ of FIG. 1 is depicted as a WTRU that is in preparation for handover. Accordingly, the WTRU 110′ enters the RRC_Connected state and retrieves the handover (HO) candidate set measurement parameters (step 310).

These parameters, which will be described in greater detail below, may include, for example, an on or off measurement command, an intra-frequency neighboring cell list, a measurement ID, a measurement quantity, an HO measurement threshold, a maximum number of cells in an HO candidate set (N_{max-candidate}), a measurement scheduling number, a time to trigger, a hysteresis value, and the like.

The inter-frequency neighboring cell list parameter includes cells whose carrier frequency range is not overlapping with the serving cell and, therefore, the measurements may require gap assistance. These cells are not included in a general measurement list, (e.g., Lₘ), until required, such as if the number of cells in the HO candidate set drop below a predefined threshold.

The measurement ID parameter includes the criteria for which HO measurement events should occur for synchronizing the HO impending WTRU 110′ and serving eNB 120 with the cells of the HO candidate set. For example, the criteria may include when a cell is added to the HO candidate set, dropped from the HO candidate set, or may include a reporting of all HO candidate set cells and measurements.

The HO measurement threshold may include a measurement of receive quality or path loss for related reference symbol received power (RSRP). For receive quality, in general, the HO threshold for a handover target cell is equal to or better than the requirement for a cell that the WTRU 110′ is comfortable camping on at the cell selection or reselection stage. The difference may be considered the handover measurement threshold (M_{HO-Offset}), which may be determined in accordance with the following equation:

HO threshold=M_{HO-Offset}+Q_{qualmin}; Equation (1)

where Q_{qualmin} is the minimum cell selection quality value and M_{HO-Offset} is an additional requirement to ensure the handover candidate cell radio quality, (e.g., 0 to d, where d is a value to be determined).

The HO threshold or the MHO-Offset value may be configured by the serving E-UTRAN and signaled to the HO impending WTRU 110′. Alternatively, the HO threshold can be derived or be used from predefined default values. For example, the HO threshold could be calculated using rules in the standard, and with or without the relevant E-UTRAN parameters published in the system information broadcast.

If the measurement is the RSRP path loss, then the HO threshold may be computed in accordance with the following equation:

HO threshold=M_{HO-Offset}+Qᵣₓₗₑᵥₘᵢₙ+P_{comp}; Equation (2)

where Qᵣₓₗₑᵥₘᵢₙ is the minimum required receive (Rx) level in the cell, P_{comp} is the compensation with respect to uplink power, and M_{HO-Offset} in this case is the additional path loss compensation to ensure the handover candidate cell radio quality.

The measurement quantity parameter includes that the WTRU 110′ uses the LTE measurement quantity reference symbols received quality (RSRQ) as a measurement for handover. In general, the RSRQ is a measurement of received signal to noise ratio as the received energy per symbol or signal, divided by the power density received over the cell's transmit bandwith. The RSRQ may be computed in accordance with the agreed upon definition in the standard, or in accordance with the following equation:

$${Q}_{m} = \frac{{E}_{S} / {N}_{0}}{RSSI} ; \qquad Equation ( 3 )$$

where RSSI is the received signal strength indicator on the total received power measured on the cell's transmit bandwidth.

The measurement quantity parameter may alternatively include a measurement of the downlink path loss. In general, the path loss may be measured in accordance with the following equation:

Pathloss=target_cell_pilot_channel_{—}Tx_power−WTRU_measured_{—}RSRP; Equation (4)

where the target_cell_pilot_channel_Tx_power is usually a published figured via system information from that cell or given by the serving eNB in the configuration, and the WTRU_measured_RSRP is the received power measured on the downlink reference symbols over the cell's transmitting bandwidth. Accordingly, the WTRU 110′ measurement quantity may be defined as:

Qₘ=RSRP. Equation (5)

The measurement scheduling number parameter includes measurement scheduling algorithms that may aid in identifying HO candidate cells with the fewest possible measurements. For example, given the radio propagation property and the geography of the LTE cell deployment, cell measurement results will usually show signs of locality. That is, WTRUs on one side of the serving cell will tend to gather better measurement results on the neighbor cells of this side than cells along other sides of the serving cell. Accordingly, handover cell measurement scheduling attempts to focus cell measurements to those relevant cells, giving priority to those cells already in the HO candidate set or above thresholds. Additionally, focus may be placed on cells with a measured trend of being stronger, avoiding measuring each cell in the list in turn.

One approach to scheduling is to divide cells in a cell list for HO measurement into two groups: cells measured more often and cells measured less often.

In general, it may considered that, not including the serving cell, there are “m” cells in a cell list. Therefore, cells of a cell set in what may be referred to as a general measurement list, (Lₘ={C₁, . . . , Cₘ}), are measured at a regular measurement interval, Iᵣ, prior to a creation of any priority list. The WTRU 110′ may begin measuring the cells in the general measurement list to build a priority list. The priority list may be a subset of cells that are included in the overall HO candidate set. Accordingly, cells added to the priority list may be measured more often than those not in the priority list.

Once the WTRU 110′ has the parameters from the E-UTRAN, the WTRU 110′ can begin the procedure of generating the HO candidate set. In step 320, the WTRU 110′ adds the serving cell to the HO candidate set as the first candidate.

The WTRU 110′ then performs preparation measurements on the next cell in the monitored set (step 330). These measurements are performed in accordance with the priority list that the WTRU 110′ will build during its measurements.

In one example, the WTRU 110′ may build the priority list, Lₚ, for HO measurement by the measurement threshold alone. That is, the target cell, tₓ, is added to the priority list when it is measured above the HO threshold and removed from the priority list if the measured result is below the HO threshold a number of times consecutively. This may be referred to as a “trend down” value. Time to trigger and hysteresis may be applied at this point.

The WTRU 110′ may also build the priority list by measurement threshold and upward trending of measurement strength. For example, if the measured results of cell show that they get continuously stronger over a certain number of times in a row. This may be referred to as a “trend up.” If a measured cell, still below the HO threshold, is not getting stronger than the highest recorded figured twice, then the cell may be removed from the priority list. Time to trigger and hysteresis may be applied at this point.

When the priority list is built, (e.g., Lₚ={T₁, . . . , Tⱼ}, where j≧1, and j≦m), cells are measured at in interval of a/b·Iᵣ; where a≦b, while the general measurement list, now given by Lₘ=C₁, . . . , Cₘ₋ⱼ, is measured at an interval of c/d·Iᵣ; where c≧d. In this manner, the total measurement load in step 330 with priority scheduling may be lighter than the load with flat rate round robin scheduling, resulting in an increase in WTRU power savings.

In step 340, it is determined whether a candidate cell's measurements are equal to, or greater than, the predetermined HO threshold. If the candidate cell's measurements meet the test in step 340, then it is determined whether or not the candidate cell's measurements, such as RSRP and RSRQ, are among the top cells measured, (e.g., N_{max-candidate}), in step 370.

If it is determined in step 370 that the measured cell is among the top cells measured, then the cell is added to the HO candidate set (step 380). The WTRU 110′ reports this event when the new measurement, M_{new}, is among the top “N” best measured results in accordance with the following equation:

M_{new}≧HO threshold, and M_{new} ε {top N_{max-candidate} measured figures}. Equation (6)

In step 390, it is determined whether or not a cell is to be dropped from the HO candidate set. This is determined based upon whether or not there are a maximum number of cells in the HO candidate set. If so, the added cell replaces one of the cells in the HO candidate set that has either the lowest measurement figure or if more than one cell has the same lowest figure, the one with the longest history in the set. The cell selected for replacement is then dropped (step 360).

If, in step 340, the cell measurement is not great than or equal to a predefined threshold, then it is determined if the cell is in the HO candidate set (step 350). If the cell is in the set, then the cell is removed from the HO candidate set (step 360). This removal is reported by the WTRU 110′ to the E-UTRAN.

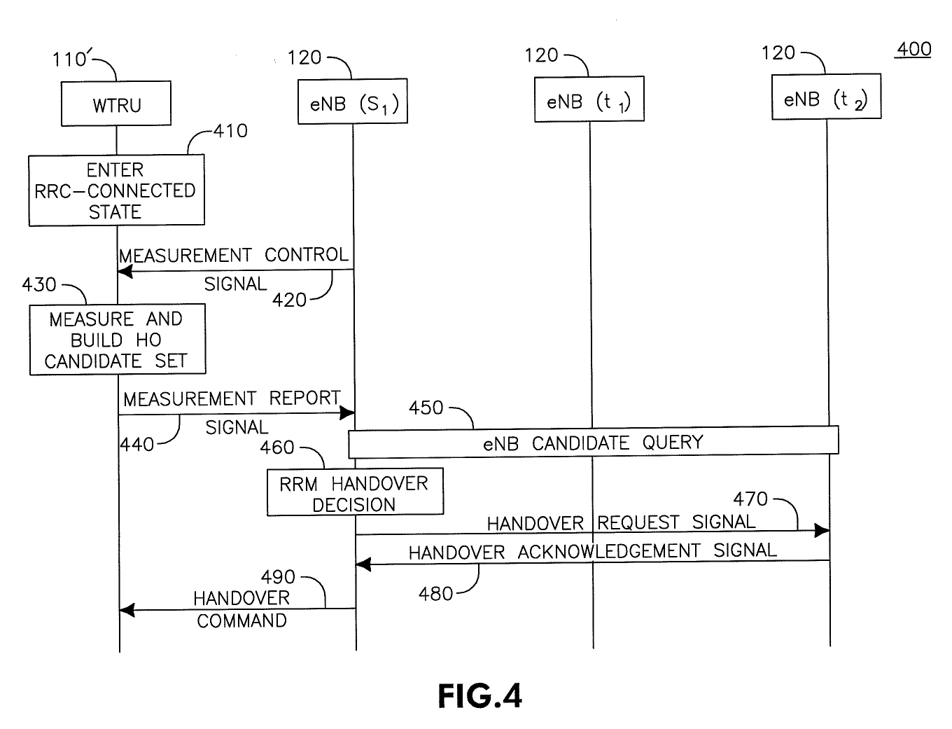

Once the HO candidate set is built, it may be utilized when a handover is imminent. FIG. 4 is an example signal diagram 400 showing a handover sequence using a handover candidate set. As shown in FIG. 4, the WTRU 110′, the Node-B 120 from the serving cell (designated eNB(S₁)), the Node-B 120 from target cell t₁ (designated eNB(t₁), and the Node-B 120 from target cell t₂ (designated eNB(t₂)) are in communication with one another. The WTRU 110′ enters the RRC_Connected state (410) and receives a measurement control signal 420 from eNB(S₁). Included in the measurement control signal are the HO parameters from the E-UTRAN. These parameters remain valid for the WTRU 110′ for as long as the WTRU 110′ remains in the current serving cell S₁ and in the RRC Connected state, unless the E-UTRAN determines to inform the WTRU 110′ to stop HO measurements and/or handover reporting. Additionally, if the WTRU 110′ is successfully handed over to another cell or if the WTRU 110′ enters an RRC_Idle state, then the parameters become invalid.

The WTRU 110′ then performs measurements and builds the HO candidate set (430) in accordance with the parameters received. When a measurement event occurs, the WTRU 110′ transmits a measurement report signal 440 to eNB(S₁). The measurement events may include as described above, when a cell is added or dropped from the HO candidate set. In addition, an aggregate of all HO candidate set cells and their measurement statistics may be reported by the WTRU 110′ to eNB(S₁) via the measurement report signal 440. This alternate reporting may be ordered by the E-UTRAN, for example, when the handover impending WTRU 110′ detects that the eNB(S₁) has dropped out of the HO candidate set or the eNB(S₁) measurements are below the HO threshold. The alternative reporting can also be ordered immediately.

When the WTRU 110′ reports that a cell has been dropped from the HO candidate set, then the E-UTRAN removes the cell. On the WTRU 110′ side, time to trigger and hysteresis may apply if a configured parameter in accordance with the following equation:

M_{new}<HO threshold−H_{HO-candidate-set}. Equation (7)

When the WTRU 110′ reports that a cell is added to the HO candidate set, the E-UTRAN adds the cell and its measurement figures to the HO candidate set for the WTRU 110′. In this case, the time to trigger and hysteresis may apply in accordance with the following equation:

M_{new}≧HO threshold+H_{HO-candidate-set} and M_{new} ε {top N_{max-candidate} measured figures}. Equation (8)

Some other conditions where the WTRU 110′ may be configured to perform and report measurements include where the WTRU uplink measurement in the serving cell is deteriorating, when the WTRU initiates new services that may be served better in other cells, when the serving cell is experiencing overloading, and when eNB(S₁) needs to be out of service, such as for maintenance reasons.

The eNB(S₁) processes the measurement reports received from the WTRU 110′ and may aid in managing the HO candidate set for the WTRU 110′. One way in which this may be performed is via an eNB candidate query (450). This query may be accomplished by eNB(S₁) querying an inter-eNB measurement database to gather the status of each candidate cell, or eNB(S₁) may query each candidate cell, (e.g., eNB(t₁) and eNB(t₂)), over the X2 interface for their handover acceptance status.

After all of the information is gathered, the eNB(S₁), based on the radio resource management (RRM) LTE strategy, and the candidate cell information, makes an RRM handover decision (460) by selecting a suitable target cell to handover the WTRU 110′. The eNB(S₁) may make this decision for several reasons. For example, if the WTRU 110′ signals that the serving cell has been removed from the HO candidate set, the serving cell measurement is below the HO threshold, or various other RRM factors. Some of these factors may include, for example, load factors, (e.g., the number of WTRUs connected, total cell/basestation bandwidth usage, connection/channel allocation failure rate), inter-cell-radio-interference, network-determined-preemption-on-some-cells, etc from the related/candidate cells

For purposes of example, referring back to FIG. 1, two target cells have been shown (t₁ and t₂) for handing over WTRU 110′. It may be the case that target cell t₁ has stronger downlink signals. However, t₁ may be overloaded, making t₂ a more optimal cell for which to handover WTRU 110′, satisfying quality of service (QoS) requirements and the like. This may aid in reducing handover rejection rate and minimize the handover “ping-pong” effect from rapid handing over from target cell and back.

Accordingly, for purposes of example, target cell t₂ is selected for handover and eNB(S₁) transmits a handover request signal 470 to eNB(t₂). The eNB(t₂) responds to the eNB(S₁) with a handover acknowledgement signal 480. A handover command 490 is then transmitted from the eNB(S₁) to the WTRU 110′ so that it may begin handover procedures.

In order to combat general fading effects and possible measurement anomalies, time to trigger and hysteresis value parameters may be provided by the E-UTRAN network to the WTRU 110′. In this manner, the WTRU 110′ may be able to smooth out jittery measurement and stabilize the membership of the handover candidate set.

A time to trigger timer (T_{Time-to-trigger}) is used to delay the set update or event report by waiting for the confirmation of the measurement result during a period of time. The timer is activated when the threshold is passed over/dropped below the first time. If the measurement maintains or solidifies the first reading during the timer period, the set update or event report action is determined at the end of the timer period.

A hysteresis value (H_{HO-candidate-set}) is provided and used to significantly distinguish one measurement value from the other. It should also be noted that the timer for time to trigger and the hysteresis value can be applied to both the “add to set” and “drop from set” actions. If both actions should happen together, (i.e., a better cell is replacing one not as good), the timer and the hysteresis apply to the “add to set” part.

Although features and elements are described above in particular combinations, each feature or element can be used alone without the other features and elements or in various combinations with or without other features and elements. The methods or flow charts provided herein may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for handover using a handover (HO) candidate set, comprising:
receiving measurement statistic parameters;
measuring statistics in a serving cell;
measuring statistics in potential target cells;
generating the HO candidate set based upon the measured statistics in the serving cell and potential target cells;
reporting the measured statistics; and
handing over to one of the potential target cells, wherein a decision to handover to the one of the potential target cells is based upon the measured statistics of the cells in the HO candidate set.

2. The method of claim 1, further comprising adding a potential target cell to the HO candidate set based upon a handover threshold statistic being greater than or equal to a handover threshold.

3. The method of claim 2, further comprising dropping a cell from the HO candidate set.

4. The method of claim 3 wherein the cell dropped from the HO candidate set is a cell having a lowest measurement statistic.

5. The method of claim 4 wherein a cell having a longest history in the HO candidate set of a plurality of cells in the HO candidate set is dropped, wherein the plurality of cells have the same lowest measurement statistic.

6. The method of claim 1, further comprising adding the serving cell to the HO candidate set.

7. The method of claim 1 wherein reporting the measured statistics included reporting cells added or dropped from the HO candidate set.

8. The method of claim 1, further comprising creating a priority list containing cells for measurements.

9. The method of claim 8 wherein cells in the priority list are measured at a different interval than cells not in the priority list.

10. The method of claim 8 wherein a cell is added to the priority list when it is measured above the handover threshold.

11. The method of claim 8 wherein a cell is added to the priority list when it is measured above the handover threshold and has a stronger measurement over a number of measurements.

12. The method of claim 8 wherein a cell is dropped from the priority list if it is measured below the handover threshold over a number of measurements.

13. A wireless transmit/receive unit (WTRU), comprising:
a receiver;
a transmitter; and
a processor in communication with the receiver and the transmitter, the processor configured to receive measurement statistic parameters, measure statistics in a serving cell, measure statistics in potential target cells, generate a HO candidate set based upon the measured statistics in the serving cell and potential target cells, report the measured statistics, and hand over to one of the potential target cells, wherein a decision to handover to the one of the potential target cells is based upon the measured statistics of the cells in the HO candidate set.

14. The WTRU of claim 13 wherein the processor is further configured to add a cell to the HO candidate set.

15. The WTRU of claim 14 wherein the processor adds a cell to the HO candidate set when the cell has a measurement greater than or equal to a handover threshold.

16. The WTRU of claim 13 wherein the processor is further configured to remove a cell from the HO candidate set.

17. The WTRU of claim 16 wherein the processor removes a cell from the HO candidate set having a measurement less than the handover threshold.

18. A Node-B, comprising:
a receiver;
a transmitter; and
a processor in communication with the receiver and the transmitter, the processor configured to transmit a measurement control signal that includes handover measurement parameters, receive a measurement report signal including a report of measurements of statistics in potential target cells for handover, determine a cell for handover, and transmit a handover command that indicates a cell for a wireless transmit/receive unit (WTRU) to handover.

19. The Node-B of claim 18 wherein the processor is further configured to perform a candidate query to determine a potential target cell for handover.

20. The Node-B of claim 19 wherein the processor is further configured to query an inter-eNB measurement database to gather the status of each candidate cell.

21. The Node-B of claim 19 wherein the processor is further configured to query each candidate cell for its handover acceptance status.
